(19) United States
(12) Patent Application Publication
(10) Pub. No.: US 2015/0374470 A1
(43) Pub. Date: Dec. 31, 2015

(54) Apparatus and process for killing oral bacteria

(71) Applicant: Ray M. Alden, Raleigh, NC (US)

(72) Inventor: Ray M. Alden, Raleigh, NC (US)

(21) Appl. No.: 14/120,805

(22) Filed: Jun. 30, 2014

(51) Int. Cl. A61C 19/06; A61C 17/16

(52) U.S. Cl. CPC A61C 19/06; A61C 17/16

(57) ABSTRACT

The present invention is a system to kill bacteria on surfaces of teeth, gums, cheeks, and the tongue. The present invention is a system of creating and applying heat within the oral cavity to kill bacteria. As taught herein, the invention also applies heat within the oral cavity to kill bacteria underneath surface layers. Applying heat to a tooth penetrates to elevate temperature and thereby kill bacteria on and within tooth layers including enamel, dentin, pulp, nerve, apical foramen, periodontal ligament, cementum, and root nerve as well as in gun and bone tissues surrounding the tooth. The invention uses conductive heat energy and radiant heat energy.

### BACKGROUND

1. Field of Invention

This invention relates to an apparatus and process for killing oral bacteria. An apparatus is manufactured to include a heating element surrounded by a non-abrasive encapsulation. The apparatus is inserted into a user's mouth to come in physical contact with mouth parts such as teeth, tongue, cheeks, and gums. The heating element raises the temperature of mouth parts thereby killing bacteria. This process helps improve oral hygiene by killing bacteria on surfaces, underneath surfaces, and within tissues.

2. Description of Prior Invention

Many methods of reducing bacteria in the human oral cavity are well known and widely practiced.

Mechanical systems are used to physically brush, scrape, pick, buff, floss or otherwise come into mechanical contact with teeth to mechanically remove bacteria from teeth. Such mechanical apparatuses are first manufactured, then placed within the oral cavity by a user, and then operated by the user to mechanically contact teeth, the tongue, cheeks, and/or gums. The mechanical energy removes bacteria from surfaces within the oral cavity. Electromechanical systems such as electric tooth brushes are an example of an electric product that interfaces with the oral cavity and applies mechanical energy to remove bacteria from the surfaces of teeth.

Chemical processes are used to kill bacteria within the oral cavity. Listerine is one such product that has been utilized for about 100 years. It is one of many chemicals used by the industry now known as mouthwash specifically for the purpose of killing oral bacteria. The product is first manufactured as a liquid chemical mixture and purchased by a user. The mouthwash is then poured into the oral cavity by the user and swished around to come in contact with teeth, the tongue, cheeks, and gums thereby killing bacteria on these surfaces within the oral cavity.

Sound wave systems are used to physically vibrate oral tissues to agitate and loosen undesired plague and bacteria from surfaces. Electromechanical systems such as sound wave generators are an example of an electric product that interfaces with the oral cavity and apples sound wave energy to remove bacteria from the surfaces of teeth.

Ultraviolet light wave systems are used to whiten teeth and to kill bacteria on the surface of teeth. They are an example of a system that converts electrical energy to photon energy which is applied to surfaces within the oral cavity to kill bacteria. Ultraviolet light wave reportedly damages skin and soft tissues and dries teeth and makes teeth more porous and prone to staining.

In the prior art a user operated system for heating teeth, guns, cheeks, and the tongue for the purpose of killing bacteria on surfaces and underneath surfaces has not been available.

### BRIEF SUMMARY

The present invention is a system to kill bacteria on surfaces of teeth, gums, cheeks, and the tongue. The present invention is a system of creating and applying heat within the oral cavity to kill bacteria. As taught herein, the invention also applies heat within the oral cavity to kill bacteria underneath surface layers. Applying heat to a tooth penetrates to elevate temperature and thereby kill bacteria on and within tooth layers including enamel, dentin, pulp, nerve, apical foramen, periodontal ligament, cementum, and root nerve as well as in gun and bone tissues surrounding the tooth. The invention uses conductive heat energy and radiant heat energy.

### Objects and Advantages

Accordingly, several objects and advantages of the present invention are apparent. The present invention utilizes conductive thermal and or radiant heat energy to elevate temperature on surfaces within the oral cavity. The present invention utilizes conductive thermal and or radiant heat energy to elevate temperature underneath surfaces accessible from within the oral cavity. The heat of the invention kills bacteria and viruses on surfaces within the oral cavity including on teeth, gums, cheeks, on the tongue, and all types dental work such as fillings, crowns, dentures, and bridges. The heat of the invention kills bacteria and viruses under the surfaces of teeth, gums, cheeks, the tongue, and all types dental work such as fillings, crowns, dentures, and bridges.

The invention reduces pain in users by several processes. First most human harbored pathogens including bacteria and viruses will not survive an elevated temperature. Thus raising the temperature of a tooth and surrounding tissues kills bacteria and viruses within the tooth and surrounding tissues. Second, elevating local temperature increases blood flow within the area of elevated temperature. This increased blood flow helps improve the health of tissues and to remove waste from tissues and thereby reduces inflammation and pain. Third, heat causes physical expansion of materials. That is to say that solids within the tooth expand when elevated in temperature. The warming process can be utilized to expand materials within the tooth to a greater extent than they are subjected to in normal use. The greater expansion causes solids to exaggerate physical distortion during the heating such that when lesser physical distortion occurs in normal use the users pain caused by physical expansion is eliminated.

Further objects and advantages will become apparent from the enclosed figures and specifications.

### DRAWING FIGURES

FIG. 1a illustrates an oral cavity heating appliance layers and the layers within and surrounding a tooth.

FIG. 1b illustrates an electric circuit for an electric powered oral cavity heating appliance.

FIG. 2 illustrates an oral cavity heating appliance engaging a plurality of teeth.

FIG. 3 illustrates select components within an electric powered conductive heat oral cavity heating appliance.

FIG. 4 illustrates select components within an electric powered radiant heat oral cavity heating appliance.

### ELEMENTS WITHIN DRAWING FIGURES

19 oral heating appliance
19a electric conductive heat oral heating appliance
19b electric radiant heat oral heating appliance
21 non-abrasive upper surface
23 non-abrasive lower surface
25 heating element
25a Nickel-Chromium wire
25b infrared LED
25d heating assembly
26 stoneware bottom
28 stoneware top
31 Power source
32 infrared transparent plastic bottom
33 AC DC converter
34 infrared transparent plastic top
35 potentiometer intensity control
71 tooth
73 enamel
75 root
77 bone
79 gum
81 dentin
83 pulp chamber

### DETAILED DESCRIPTION OF THE INVENTION

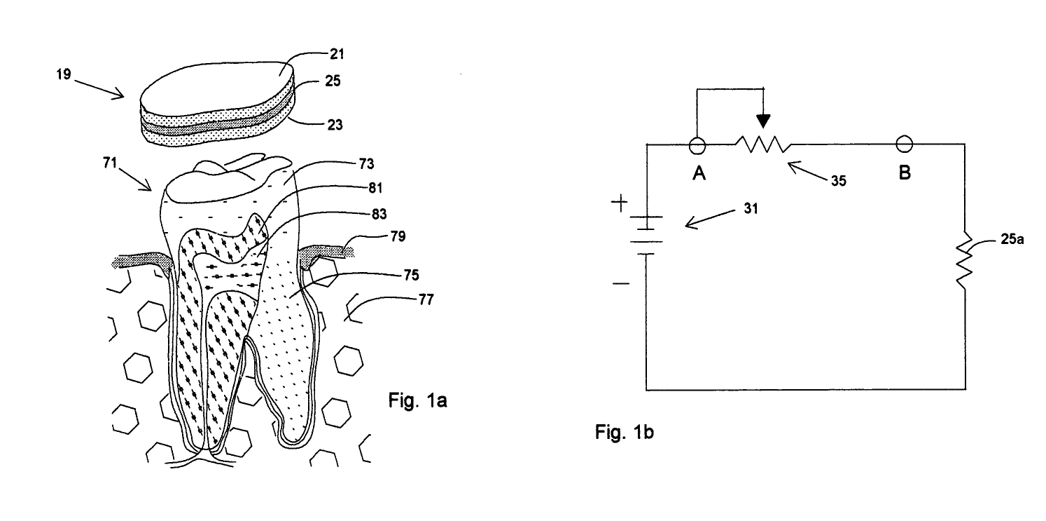

FIG. 1a illustrates an oral cavity heating appliance layers and the layers within and surrounding a tooth. An oral heating appliance 19 comprises a non-abrasive upper surface 21 and a non-abrasive lower surface 23. A discussed in subsequent diagrams, the oral heating appliance 19 is first manufactured and then used by a user wherein it is inserted into the user's oral cavity so as to apply heat to the user's body parts such as teeth, gums, cheeks, and the tongue. Within the user's oral cavity is a tooth 71. In the present invention conductive thermal energy or radiant thermal energy from the oral heating appliance 19 warms the tooth including the tooth's surface and underlying layers and tissues. The warming kills bacteria on the surface of the tooth and the warming kills bacteria in underlying layers and tissues. The outer layer of the tooth 71 is enamel 73. The oral heating appliance 19 engages the exposed outer tooth enamel 71 and transmits thermal energy. Whether conductive or radiant, the thermal energy penetrates the tooth enamel to also warm a root 75 below the gum line of the tooth, a bone 77 into which the tooth is lodged, a gum 79 that surrounds the tooth and root border, a dentin 81 layer within the tooth, and a pulp chamber 83 within the tooth. The thermal energy received by each of these tissues kills bacteria residing therein. Additional tissues in proximity to the tooth receive thermal energy that kills bacteria including the apical foramen, periodontal ligament, cementum, and root nerve. Thus thermal conductive energy and thermal radiant energy applied within the oral cavity kills surface bacteria and also bacteria in underlying tissues.

The oral cavity is often referred to as a harsh environment partly because of the range of temperatures that it is exposed to. People are accustomed to eating very cold things such as ice cream and also very hot meals and drinks such as hot soup and hot coffee. Temperatures of items ingested can range from around 32° f to around 212° f (the boiling point of water). As temperatures within the oral cavity change, teeth, fillings, crowns and dentures expand and contract. Teeth with defects often exhibit pain when subjected to temperature changes from body temperature to cold or from body temperature to hot.

In experimentation, a user test subject had been experiencing pain when hot food came into contact with a molar. As described herein the oral cavity heating appliance was used to slowly elevate the molar's temperature to reach 120° f and the 120 f temperature was maintained for 3 minutes. During this heating process, no pain was perceived by the user test subject. After the process was completed, the user ate hot foods periodically and was asked to rate his pain from the molar. Since the process of heating the molar, the users has experience no pain from the molar over 2 months later.

Several processes are attributed to the success of reducing pain in the molar. First most human harbored pathogens including bacteria and viruses will not survive an elevated body temperature. The body's response to bacterial and viral infection is to elevate its own temperature by only a few degrees for example a fever of between 100° f and 105° f is known to assist in killing bacteria and viruses within the body. Thus raising the temperature of the tooth and surrounding tissues killed any small infection within the tooth and within the tissues surrounding the tooth. A second effect known to occur by elevating local temperature is an increased blood flow within the area of elevated temperature. This increased blood flow helps improve the health of tissues and to remove waste from tissues thus reducing inflammation. A third effect is physical expansion of materials. That is to say that solids within the tooth expand when elevated in temperature. The warming process can be utilized to expand materials within the tooth to a greater extent than they are subjected to in normal use. The greater expansion causes solids to exaggerate physical distortion during the heating such that less physical distortion occurs in normal use and therefore the user's pain caused by physical expansion is eliminated.

In the most simple example of the manufactured oral heating appliance 19, a heating element 25 is first manufactured to the desired shape. The heating element is a ceramic fabrication made from kiln fired stoneware clay. Stoneware based ceramics are able to absorb and retain high thermal energy. Once the desired stoneware shape is manufactured, it is encapsulated in medical grade plastic such as silicone. Medical grade silicone with biocompatibility and properties such as optical transparency, infrared transparency, efficient heat transfer, stability through suitable temperature ranges, and suitability for microwaving are available from manufacturers such as Dow Corning, Bayer, Nusil, and Applied Silicone Corp. The non-abrasive upper surface 21 and a non-abrasive lower surface 23 are comprised of the medical grade plastic that encapsulates the heating element 25. Just prior to use, the oral heating appliance 19 is charged with heat using either method of submerging in boiling water for several minutes or microwaving within the microwave oven for 60 second or less depending upon size. Once the oral heating appliance 19 is charged with heat it is ready for insertion into the oral cavity whereupon its stored heat is conducted and or radiated into the tooth 71 and or other tissues within the mouth.

While the above describes a system for first heating the oral appliance and then inserting into the user's mouth, FIG. 1b, 2, 3, and 4 describe electrically powered oral appliances that can be inserted into the mouth and then heated.

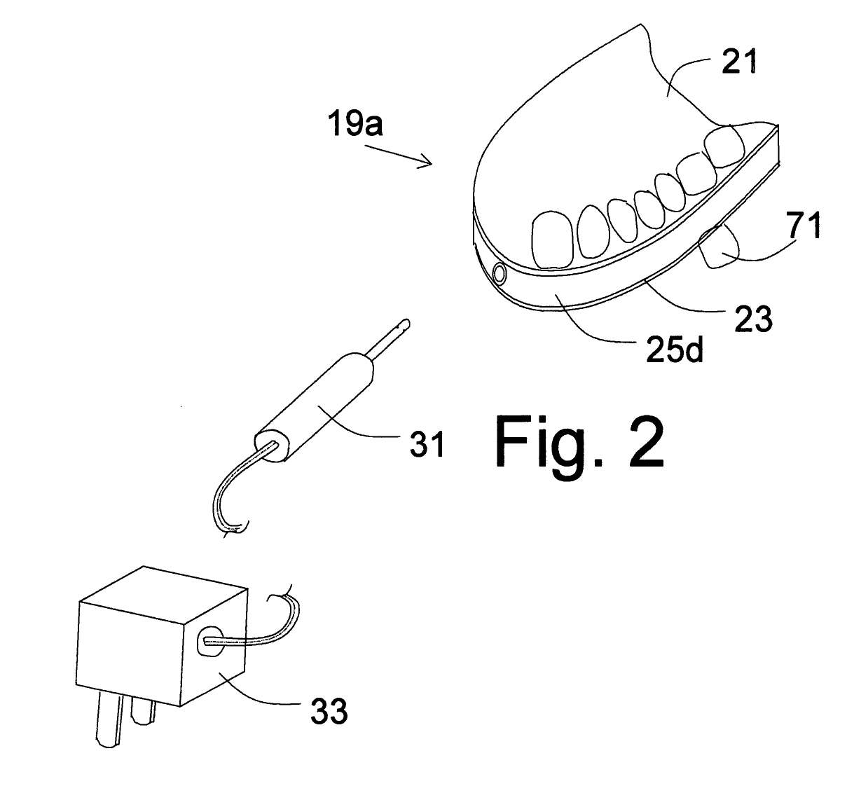

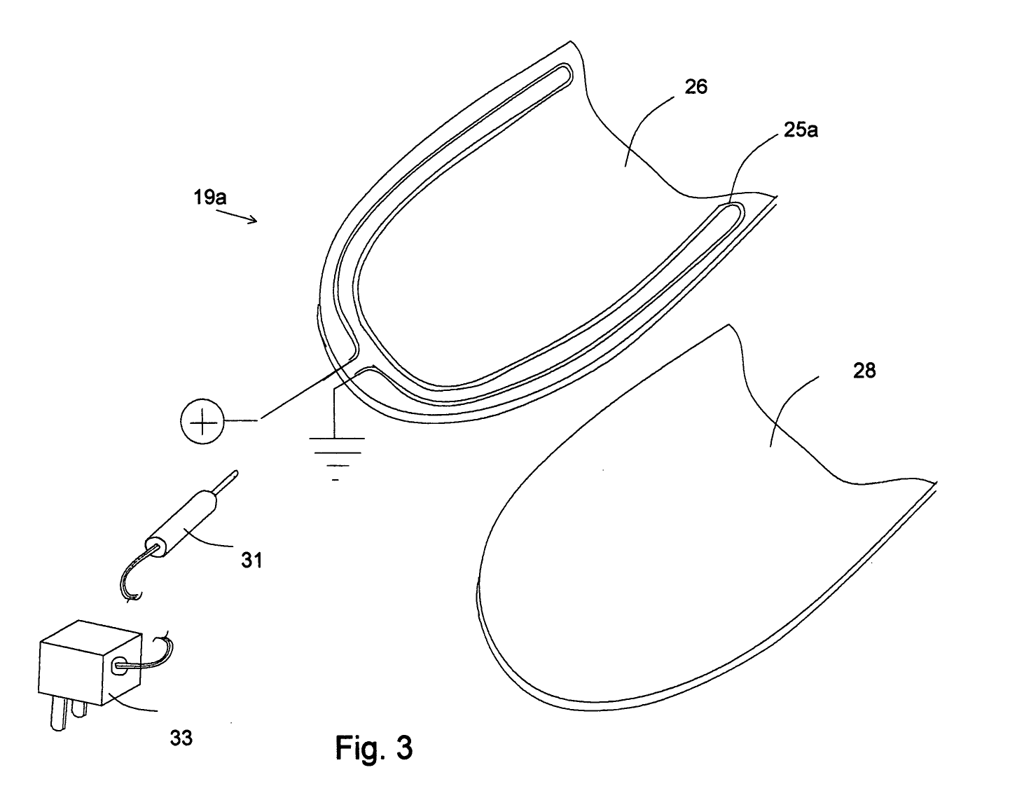

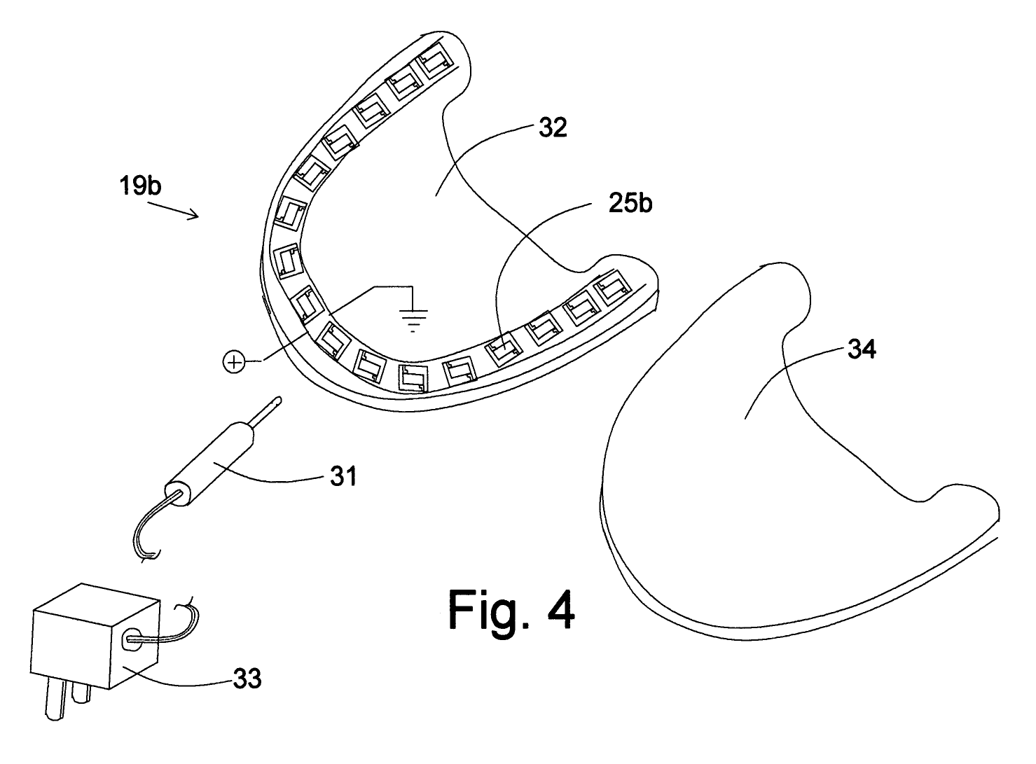

FIG. 1b illustrates an electric circuit for an electric powered oral cavity heating appliance. A very simple electric circuit is used to power an electric appliance of the present invention. A power source 31 provides electric current to the circuit, a potentiometer intensity control 35 can be adjusted by the user to control the temperature intensity or the infrared light intensity. The circuit powers a Nickel-Chromium wire 25a heating element of FIG. 3 or an infrared LED 25b emitter of FIG. 4. The electric circuit is incorporated into the manufactured appliance fabrications of FIGS. 2, 3, and 4 and along with the other components of those Figures is encapsulated within the medical grade plastic or silicone such that components are chemically, electrically, and medically inert to the user.

FIG. 2 illustrates an oral cavity heating appliance engaging a plurality of teeth. An electric conductive heat oral heating appliance 19a is a manufactured fabrication that comprises a heating assembly 25d such as is described in FIGS. 1b, 3 and 4. The power source 31 comprises a DC plug that plugs into the heating assembly 25d to be electrically in communication with the electric circuit therein. Connected to the power source is an AC DC converter 33 which can be plugged into a standard wall outlet. When manufactured, the electric conductive heat oral heating appliance 19a can be manufactured to engage multiple teeth concurrently or a single tooth, or be shaped to engage with teeth, gums, cheeks, and/or the tongue concurrently. The non-abrasive encapsulation serves several purposes, including binding components together into a single appliance, being comfortable and non-abrasive within the mouth, insulating the user from internal contents and insulating the user from the electric current.

FIG. 3 illustrates select components within an electric powered conductive heat oral cavity heating appliance. During manufacture, the electric conductive heat oral heating appliance. starts with fabrication of a thin stoneware bottom 26 approximately ¼ inch thick and shaped to fit within a user's mouth. Affixed to the stoneware bottom 26 is the Nickel-Chromium wire 25a which is laid out and positioned in a dental shaped pattern and also engages with circuit of FIG. 1b. Affixed on top of the Nickel-Chromium wire 25a is a stoneware top 28 to form a rigid sandwich of a stoneware layer, a nickel-chromium layer and then a stoneware layer. The assembly is then encapsulated within medical grade plastic such that the appliance outside is completely plastic except that a plug port is available to receive the power source 31 plug. In operation, once the appliance is plugged in, the high resistance Nickel-Chromium wire 25a receives electric current and efficiently transforms it into heat. As the Nickel-Chromium wire 25a heats up, it heats the stoneware bottom 26 the stoneware top 28. The assembly can be first heated and then placed within the users mouth to elevate temperature therein or the assembly can be first placed within the users mouth and then heated to elevate temperature therein. In any case, the appliance elevates the temperature on surfaces and underneath surfaces of teeth, gums, cheeks, and the tongue thereby killing bacteria and viruses.

FIG. 4 illustrates select components within an electric powered radiant heat oral cavity heating appliance. A 19b electric radiant heat oral heating appliance is fabricated by first producing an infrared transparent plastic bottom 32 and an infrared transparent plastic top 34. These are stamp cut pieces of rigid plastic that are flat, transparent in the infrared light spectrum, and do not breakdown when subjected to infrared light. In later steps of manufacture, the plastic substrate prevents encapsulating plastic from optically interfering with the infrared LED 25b designed emittance cone. The infrared LED 25b is affixed to the surface of the infrared transparent plastic bottom 32 along with an array of similar LEDs such that each LED is in electric communication with the power supply 31. The LEDs are positioned to transmit infrared light also known as radiant heat to each of 16 teeth on the upper jaw or the lower jaw of a user during subsequent use. Affixed on top of the LED array is the infrared transparent plastic top 34. This sandwich assembly of plastic, LEDs, then plastic is encapsulated within medical grade plastic such that the appliance outside is completely non-abrasive plastic except that a plug port is available to receive the power source 31 plug. In operation, the appliance is placed within the user's mouth and then plugged in. The powered LEDs emit infrared light which is radiant heat that warms teeth, gums, cheeks, and the tongue. The elevated temperature kills bacteria on surfaces within the mouth and under the surfaces.

During manufacturing many LED choices are available. For example Digi-key supplies surface mount infrared spectrum LEDs operating at wavelengths from 700 nm and higher operating at voltages below and above 1 volt. They come with a range of viewing angles to enable concentration of infrared energy within a viewing angle 45° or less. The lower the viewing angle the more focused the energy. For experimentation a Vishay LED, VSMY98545, was selected. Its physical dimensions are 2.2 mm height and 3.85 mm length and width. During appliance manufactured, the LEDs are soldered to electrical leads in electrical communication with the circuit of FIG. 1b replacing the nickel-chromium wire 25a. Each LED operates at 1 amp and 1.8 volt to emit a radiant thermal energy intensity of 230 mW/sr. In our assembly, each LED will raise the targeted tooth and tissues by approximately 3° per minute. During manufacture, additional LEDs can be added to increase radiant energy output as needed.

Thus the preceding describes a process for killing bacteria using a heating element to heat to surfaces within the oral cavity and to kill bacteria residing upon the surfaces. The preceding also describes a process for killing bacteria residing in tissues and structures underlying surfaces within the oral cavity by heating those tissues and structures.

### Operation of the Invention

Operation of the invention has been discussed under the above under the Detailed Description of the Invention heading and is not repeated here to avoid redundancy.

### CONCLUSION, RAMIFICATIONS, AND SCOPE

Thus the reader will see that the apparatus and process for killing oral bacteria of this invention provides a well defined and desirable consumer product that improves hygiene, is low cost, easily manufactured and user friendly. While the above description describes many specifications, these should not be construed as limitations on the scope of the invention, but rather as an exemplification of a preferred embodiment thereof. Many other variations are possible.

The example given herein specifies temperature elevation of a tooth and surrounding tissues both above and beneath the surface. Another example that is not mentioned explicitly is that of dental work such as fillings, crowns, bridges, and dentures. Elevating the temperature of such dental work and surrounding tissues is very helpful in killing bacteria under the dental work that cannot be reached by brushing. Also surface tissues and underlying tissues that make up the gum, cheeks, and tongue benefit from the temperature elevation process described herein. Everything within a user's oral cavity or accessible there through is within the scope of the invention.

An example is given of a very simple electric circuit used to control electric heating appliances herein. Many other circuits are possible. Some examples include timers to control the duration of use, temperature sensors to provide temperature feedback from the appliance to be used to set and maintain a specific temperature (or light intensity) at the appliance, a circuit to slowly increase appliance temperature (or light intensity) to a desired peak temperature and to slowly decrease appliance temperature back to body temperature. Circuits can be adjusted to accommodate different amps, watts, and voltages. While a specific LED is described herein, many different LEDs can be substituted to change the intensity, wavelength, broadcast angle, and physical dimensions. An infrared light sensor can be added to sense intensity of energy being emitted through surrounding tissues. DC current is used with the electric appliance but AC current can be substituted. More than 1 LED can be directed at an individual tooth in increase the radiant heat applied to the tooth.

An induction coil can be substituted for the power supply so that the system can be heated wirelessly.

The encapsulated appliance can incorporate a phase change sodium acetate material as the means to generate heat. After use, the phase change material be regenerated by boiling. The encapsulated appliance can incorporate an exothermic chemical reaction as the means to generate heat. The stoneware clay can be replaced by many materials for heat storage.

The appliance herein can be modified to heat upper teeth and lower teeth concurrently.

While an example is given of raising tooth and surrounding tissue temperatures to 120° f, to achieve desired effects, the appliance can be used to achieve peak temperatures ranging from body temperature up to 212° f. Although not all temperatures in this range of advisable or desirable.

What is claimed:

1) A process for killing bacteria wherein,
A heating element is provided,
The heating element is placed within the oral cavity of a user,
Heat from the heating element is transferred from the heating element to surfaces within the oral cavity,
Wherein bacteria residing upon the surface of the oral cavity are killed.

2) The process for killing bacteria of claim 1 wherein, heat from said heating element is transferred from the heating element to tissues and structures underlying surfaces within the oral cavity, Wherein bacteria residing in tissues and structures underlying surfaces within the oral cavity are killed.

3) The process for killing bacteria of claim 1 wherein, a plastic encapsulation of said heating element is provided.

4) The process for killing bacteria of claim 1 wherein, said heating element comprises a means for converting electrical energy to heat energy.

5) The process for killing bacteria of claim 1 wherein, said heating element comprises a means for converting electrical energy to infrared light energy.

6) The process for killing bacteria of claim 1 wherein, said heating element comprises a means for converting electrical energy to radiant heat energy.

7) The process for killing bacteria of claim 1 wherein, said heating element comprises a means for storing heat energy.

8) The process for killing bacteria of claim 2 wherein, a plastic encapsulation of said heating element is provided.

9) The process for killing bacteria of claim 2 wherein, said heating element comprises a means for converting electrical energy to heat energy.

10) The process for killing bacteria of claim 2 wherein, said heating element comprises a means for converting electrical energy to infrared light energy.

11) The process for killing bacteria of claim 2 wherein, said heating element comprises a means for converting electrical energy to radiant heat energy.

12) The process for killing bacteria of claim 2 wherein, said heating element comprises a means for storing heat energy.
